(19) United States
(12) Patent Application Publication
(10) Pub. No.: US 2005/0027504 A1
(43) Pub. Date: Feb. 3, 2005

(54) Job execution plan evaluation system

(76) Inventor: Satoru Watanabe, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/790,201

(22) Filed: Mar. 2, 2004

(30) Foreign Application Priority Data
Jul. 29, 2003 (JP) 2003-202767

(51) Int. Cl. G06F 9/45

(52) U.S. Cl. 703/22

(57) ABSTRACT

When evaluating the execution plan of a job executed in a computer system by using simulation, the simulation is completed and the execution plan evaluation is completed within the time desired by a user. The evaluation system includes a performance storage section for storing a performance value of a computer executing the simulation, a model database for storing a performance model used for the simulation, and a model creation section for creating a performance model from the performance model stored in the model database for use in the simulation. The model creation section modifies the method for creating the model according to the limit time input by the user and the performance value of the computer stored in the performance storage section. By using the performance model created by the model creation section, the simulation is executed and the job execution plan is evaluated.

### BACKGROUND OF THE INVENTION

The present invention relates to an evaluation system for evaluating a job execution plan.

As a problem concerning a job execution plan, for example, there is a problem of job scheduling.

In the job scheduling problem, x transactions are composed of y jobs and each of the jobs is processed by one of z computers. Each job has a predetermined time. Moreover, there is a preceding relationship between transactions constituting one transaction. Here, the job execution plan (job start time and a job executing computer) should be decided so as to minimize the total time required for completing all the transactions.

In the job scheduling problem, the total time required for completing all the transactions is used as an evaluation index for evaluating the job execution plan.

When a computer is to execute a single task (there is only one job to be executed simultaneously), the execution plan evaluation index can be calculated by adding the times required for executing the jobs according to the execution plan.

When a computer is to execute a multi-task (there are a plurality of jobs to be executed simultaneously), a plurality of jobs use the computer simultaneously and the job execution time changes, disabling calculation of the total time required only by adding the times. Accordingly, for evaluating the execution plan in the multi-task environment, discrete event simulation is widely used.

When the discrete event simulation is used, the execution plan evaluation index can be calculated even if the computer is to execute a multi-task.

For example, when the computer is to execute a multi-task, as a method for calculating the computer performance index by simulation, there is disclosed a multi-task system evaluation system, measurement method, and recording medium containing the method program (JP-A-2000-298593). The computer performance index in JP-A-2000-298593 corresponds to the job execution time. By using JP-A-2000-298593 to repeatedly calculate a job execution time, it is possible to calculate the execution plan evaluation index. Moreover, HyPerformix Inc. (US) sells software for calculating a multi-task computer performance index by using the discrete event simulation (Hyperformix Infrastructure Optimizer).

### SUMMARY OF THE INVENTION

In the aforementioned job execution plan evaluation by using the discrete event simulation, a great amount of calculation is required for executing the discrete event simulation. For this, a great time is required for the simulation execution, and there is a case that the execution plan evaluation is not completed within a time practically required.

It is therefore an object to increase the simulation execution speed and complete the execution plan evaluation within the limit time requested by a user.

For increasing the simulation execution speed, there is a method of modifying the simulation model. Since the calculation amount required for the simulation execution differs according to the simulation model, by using a simulation model which can be executed by a small amount of calculation, it is possible to increase the simulation execution speed.

The degree of matching between the simulation and the fact (simulation accuracy) varies according to the simulation model. When the simulation accuracy is low, the job execution plan evaluation becomes inaccurate. Accordingly, it is preferable that the simulation accuracy be high. When the simulation model is modified so as to increase the simulation execution speed, there is a danger that the simulation accuracy is lowered. When modifying the simulation model, lowering of the simulation accuracy should be suppressed as a second object.

An evaluation system according to the present invention comprises an input section enabling input of the job execution plan and a limit time, a model database for storing a job model, a model creation section for creating a simulation model from the job model stored in the model database, a simulation execution section for executing the simulation, an evaluation section for evaluating the execution plan from the simulation result, and an output section for outputting the evaluation result.

The evaluation system according to the present invention further comprises a performance storage section for storing a performance value of a computer executing the simulation.

The model creation section modifies the method for creating the simulation model according to the limit time input to the input section and the performance value stored in the performance storage section. With this modification of the method for creating the simulation model, the time required for executing the simulation of the simulation execution section is made equal to or below the limit time input to the input section.

The method for creating the simulation model from the job model by the model creation section includes a step of setting a parameter of the simulation model. The model creation section calculates the job interference degree from the execution plan input to the input section and modifies the simulation model parameter with a higher priority for the job model having a smaller interference degree calculated.

The job execution plan evaluation system according to the present invention can make the time required for executing simulation equal to or below the limit time input to the input section by providing a performance storage section and a model creation section.

Other objects, features and advantages of the invention will become apparent from the following description of the embodiments of the invention taken in conjunction with the accompanying drawings.

### BRIEF DESCRIPTION OF THE DRAWINGS

FIG. 1 shows an example of a computer system to which an evaluation system according to the present invention is applied.

FIG. 2 shows an example of a job execution plan.

FIG. 3 shows configuration of an evaluation system according to the present invention.

FIG. 4 shows an example of a job model according to the present invention.

FIG. 5 shows an example of a simulation model.

FIG. 6 shows the relationship between the number of simulation events and execution time.

FIG. 7 is a flowchart showing operation of a model creation section of the present invention.

FIG. 8 shows an example of a simulation model.

FIG. 9 shows an example of a simulation model.

FIG. 10 shows simulation errors.

FIG. 11 shows simulation data managed by a simulation execution section of the present invention.

FIG. 12 is a flowchart showing operation of the simulation execution section of the present invention.

FIG. 13 is a flowchart showing operation of the simulation execution section of the present invention.

FIG. 14 shows an example of a simulation result obtained by the simulation execution section of the present invention.

### DETAILED DESCRIPTION OF EMBODIMENTS

Description will now be directed to a job execution plan evaluation system according to the present invention with reference to the attached drawings.

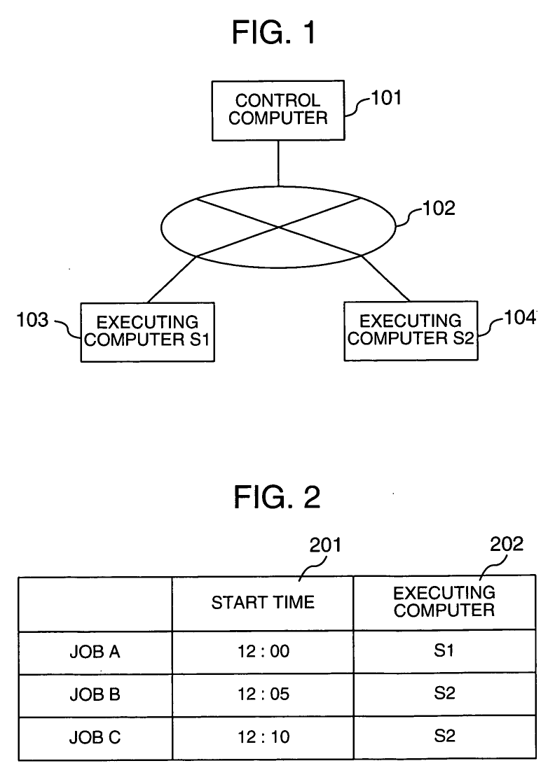

This evaluation system can be applied, for example, to a computer system consisting of a control computer 101, a network 102, an execution computer S1 (103), and an execution computer S2 (104) as shown in FIG. 1. The control computer 101 instructs, via the network 102, the execution computer S1 (103) and the execution computer S2 (104) to execute a program operating on the execution computer. The program operating on the execution computer will be referred to a job in this specification.

In the system of FIG. 1, the control computer 101 instructs execution of a job according to a job execution plan (job start time and computer executing the job). FIG. 2 shows an example of an execution plan for executing three jobs: Job A, Job B, and Job C. As shown in FIG. 2, the job execution plan consists of the job start time 201 and the executing computer 202.

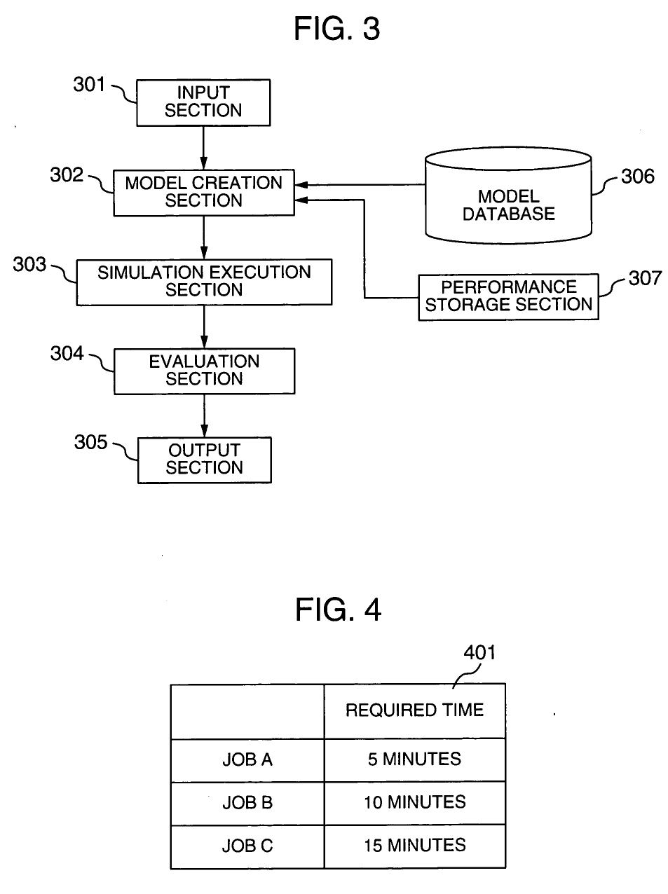

The evaluation system of the present invention is applied, for example, for evaluating relative merits of the execution plan as shown in FIG. 2. This evaluation system, as shown in FIG. 3, includes an input section 301 for receiving a job execution plan and a limit time, a model creation section 302 for creating a simulation model from a job model stored in a model database, a simulation execution section 303 for executing a simulation, an evaluation section 304 for evaluation the execution plan according to the simulation result, an output section 305 for outputting the evaluation result, a model database 306 for storing the job model, and a performance storage section 307 for storing the performance value of the computer executing the simulation.

The input section 301 consists of I/O devices such as a keyboard, a display, and a mouse. A user operates these I/O devices to input the job execution plan and the limit time which is the upper limit value of the time required for simulation execution by the simulation execution section 303. Here, the input of the job execution plan means input of each job start time 101 and the executing computer 102 as shown in FIG. 2. Moreover, the input of the limit time means input of time such as “2 minutes”.

A job model is stored in a model database 306. As shown in FIG. 4, the job model consists of a required time 401. FIG. 4 shows an example of three job models: Job A, Job B, and Job C.

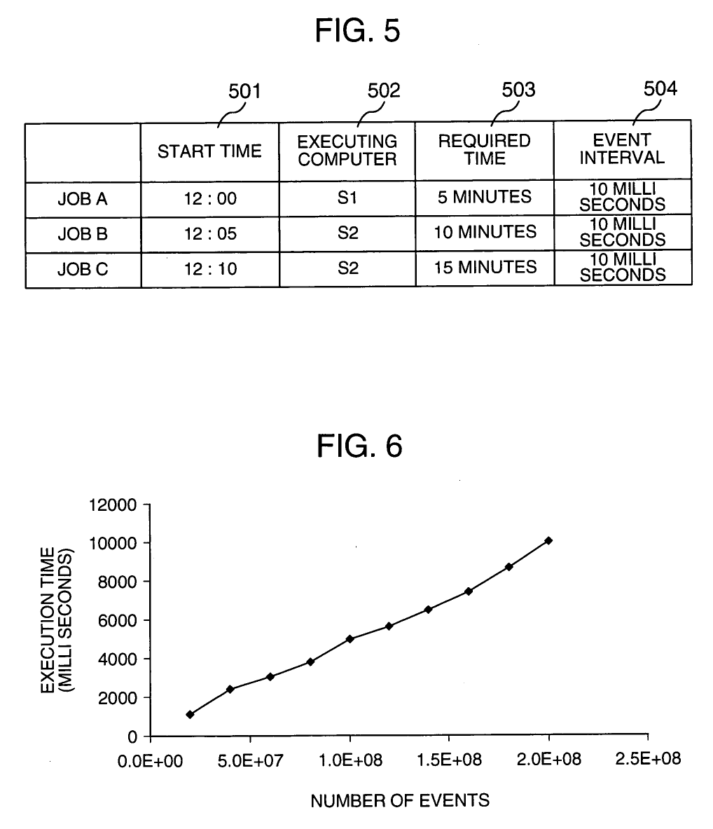

The model creation section 302 creates a simulation model from the job execution plan input to the input section 301 and the job model stored in the model database 306. The simulation model includes a start time, executing computer, required time, and event interval specified for each job in the execution plan. The start time and the executing computer are specified by the execution plan input to the input section 301 while the required time is specified from a required time of each job stored in the model database 306. The algorithm for deciding the event interval will be detailed later. FIG. 5 shows a simulation model created when the job model of FIG. 4 is stored in the model database 306 and the execution plan of FIG. 4 is input to the input section 301. FIG. 5 shows a simulation model with specification of 10 milli-seconds for the event interval. In this embodiment, this even interval corresponds to the “simulation model parameter” claimed.

It has been found that the time required for executing a discrete event simulation is proportional to the number of events generated during simulation execution and the proportionality constant is determined by the computer executing the simulation. FIG. 6 shows the result of check of executing time by executing simulations having different numbers of events by using the same computer. FIG. 6 shows a graph of a straight line, which means that the time required for executing the simulation is proportional to the number of events generated during simulation execution. The proportionality constant of the proportional relationship in FIG. 6 changes according to the computer executing the simulation.

The performance storage section 307 stores the number of events generated during the simulation execution and the proportionality constant of the simulation execution time when using a computer executing a simulation in the evaluation system. This proportionality constant is an execution time per one event and a time such as “1 milli-second” is stored.

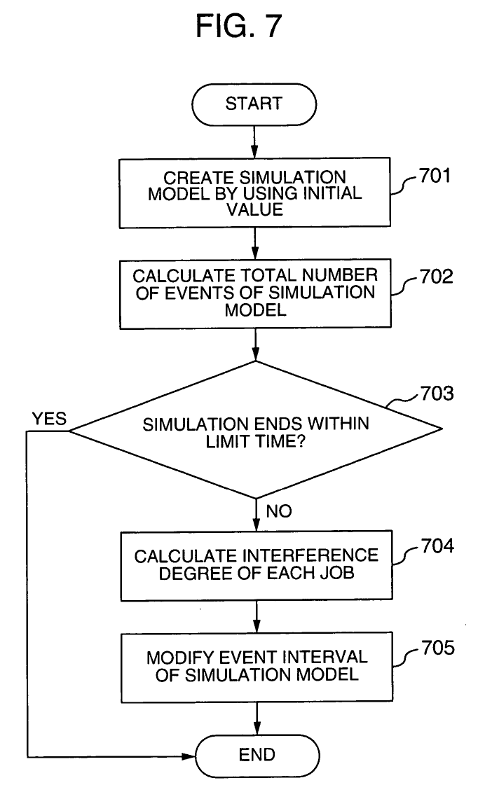

Explanation will be given on the algorithm according which the model creation section 302 decides the event interval of the simulation model. FIG. 7 shows a flowchart of the algorithm for deciding the event interval.

The model creation section 302 has an initial value of the event interval, Process 701 creates a simulation model by using this initial value. This initial value is specified by time such as “10 milli-seconds”. For example, process 701 creates a simulation model of FIG. 5

In process 702, the total number of events is calculated from the simulation model created by using the initial value. The number of events of each job of the simulation model is calculated by a required time/event interval and the total number of events is the total number of events of the jobs. For example, in the simulation model of FIG. 5, the event number of Job A, Job B, and Job C are 30,000 times (5 minutes/10 milli-seconds), 60,000 times (10 minutes/10 milli-seconds), and 90,000 times (15 minutes/10 milli-minutes), respectively. Accordingly, the total number of the events is 180,000 times (30,000 times+60,000 times+90,000 times).

Judgment 703 determines whether the simulation is completed within the limit time by using the total number of events calculated in process 702, the performance value stored in the performance storage section 307, and the limit time input to the input section. For this, the total number of events calculated in process 702 is multiplied by the execution time per event stored in the performance storage section 307 and comparison is made with the limit time. If the limit time is greater, control is passed to YES in the flowchart of FIG. 7 and if the limit time is smaller, control is passed to NO in the flowchart of FIG. 7. For example, if the total number of events in the simulation model of FIG. 5 is 180,000 times, the performance value stored in the performance storage section 307 is 1 milli-second, and the limit time is 2 minutes, then 180,000 times×1 milli-second=3 minutes, which is greater than the limit time of 2 minutes and control is passed to NO.

In process 704, the interference degree of each job is calculated from the simulation model. The job interference degree is defined by the total time of the other job executed in the same executing computer 502 during the required time 503 from the start time 501. For example, in the case of the simulation model of FIG. 5, the interference degree of Job A is 0 because no other job is executed in the same executing computer (S1) during the required time (5 minutes) from the start time (12:00), i.e., (12:00 to 12:05). The interference degree of Job B is 5 because during the required time (10 minutes) from the start time (12:05) i.e., (12:05 to 12:15), Job C is executed in the same computer (S2) and Job B and Job C are simultaneously executed for 5 minutes (12:10 to 12:15). Similarly, the interference degree of Job C is 5. When two or more jobs are simultaneously executed, the time executed simultaneously is calculated for each job and the total of them is the interference degree. This is the “total time” in the definition of the interference degree.

Process 705 increases the event interval of the simulation model until the product of the total number of events of the simulation model and the performance value stored in the performance storage section 307 becomes equal to or below the limit time input to the input section 301. Here, the event interval of the job having a smaller interference degree calculated in the process 704 is modified with a higher priority. When increasing the event interval, the upper limit is the required time of the job. In this embodiment, modification of the event interval having the smaller interference degree calculated in the process 704 corresponds to “modification of the parameter of simulation model according to the interference degree calculated” claimed.

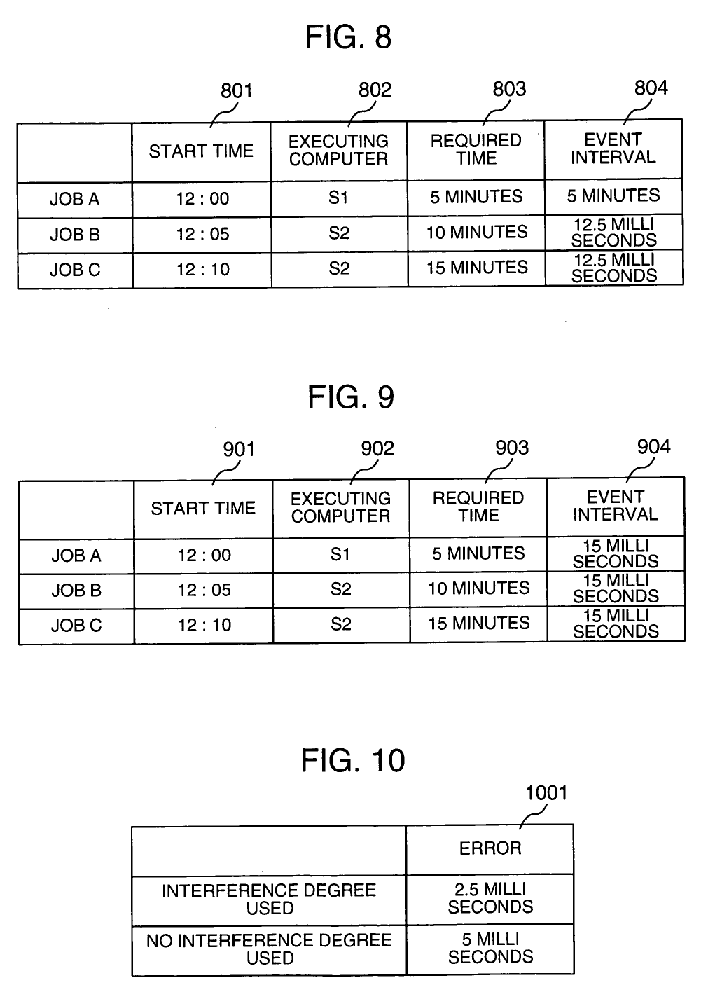

Explanation will be given on an example of the simulation model of FIG. 5 when the performance value stored in the performance storage section 307 is 1 milli-second and the limit time input to the input section 301 is 2 minutes. The interference degree of Job A, Job B, and Job C by the process 704 are 0, 5, and 5, respectively. Since the interference degree of Job A is the smallest, the event interval of Job A is increased. When increasing the event interval of Job A, the upper limit of event interval of Job A is 5 minutes since the required time of Job A is 5 minutes. When the event interval of Job A is set to 5 minutes, the total number of events of the simulation model is 150,000 times (Job A 0 time; Job B, 60,000 times; Job C, 90,000 time), and the product with the performance value (1 milli-second) is 2 minutes 30 seconds, which is greater than the limit time (2 minutes). Accordingly, the event interval of Job B and Job C having the next smallest interference degree are increased. When the event interval of Job B and Job C are set to 12.5 milli-seconds, the total number of events is 120,000 times (Job A, 0 time; Job B, 48,000 times; Job C, 72,000 times) and the product with the performance value (1 milli-second) is 2 minutes, which is equal to or below the limit time (2 minutes). Thus, process 705 modifies the event interval of Job A, Job B, and Job C to 5 minutes, 12.5 milli-seconds, and 12.5 milli-seconds, respectively. The simulation model modifies is shown in FIG. 8.

In addition to the method of modifying the event interval of the simulation model according to the interference degree as process 705, it is possible to use a method to uniformly increase the event intervals of all the jobs. For example, in the simulation model of FIG. 5, when the performance value stored in the performance storage section 307 is 1 milli-second and the limit time input to the input section 301 is 2 minutes, if the event intervals of Job A, Job B, and Job C are modified to 15 milli seconds as shown in FIG. 9, the product of the total number of events 120,000 times (Job A, 20,000 times; Job B, 40,000 times; Job C, 80,000 times) and the performance value (1 milli-second) is 2 minutes, which is equal to or below the limit time (2 minutes).

FIG. 10 shows the result of comparison based on the end time of Job B between the simulation error obtained by using the simulation model of FIG. 5 and the simulation error obtained by using the simulation model of FIG. 9. As shown in FIG. 10, the error is smaller when the event interval is modified by using the interference degree and there is a merit that the simulation accuracy is not lowered.

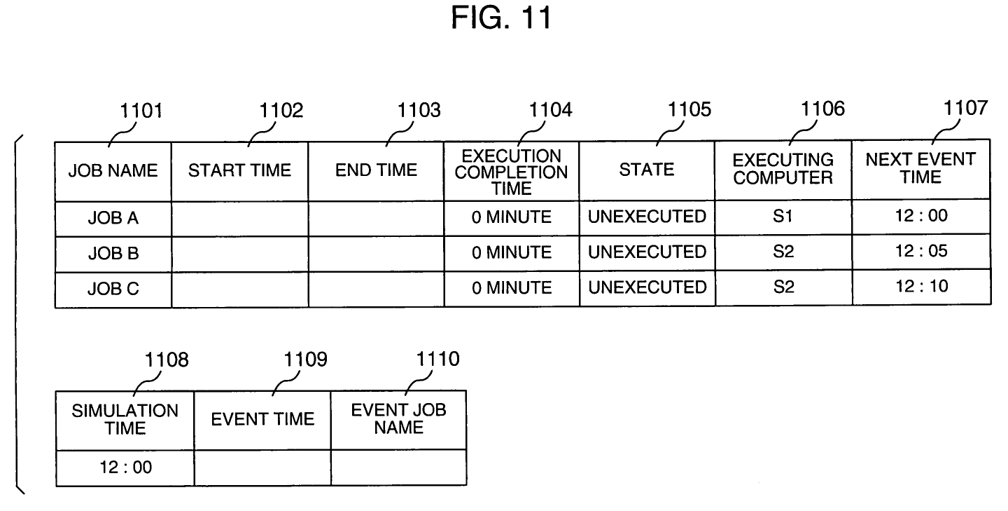

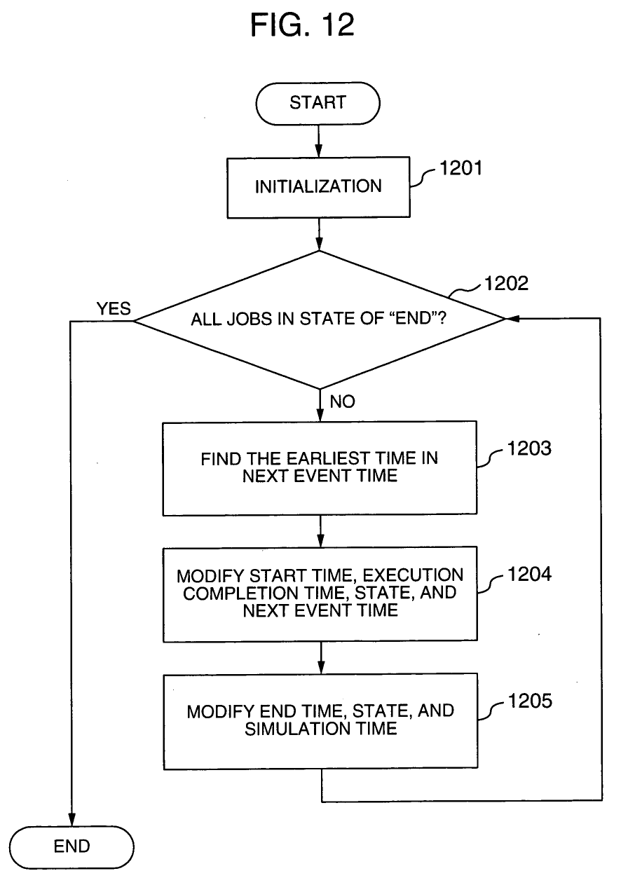

The simulation execution section 303 executes simulation by using the simulation model created by the model creation section 302. The simulation execution section 303 holds simulation data consisting of a job name 1101, a start time 1102, an end time 1103, execution completion time 1104, a state 1105, an executing computer 1106, the next event time 1107, a simulation time 1108, an event time 1109, and an event job name 1110. FIG. 11 shows an example of the simulation data. FIG. 12 is a flowchart showing operation of the simulation execution section 303. Explanation will be given on the operation of the simulation execution section 303 with reference to the flowchart of FIG. 12.

Process 1201 sets the initial value of the simulation data. For the job name 1101, all the jobs set in the simulation model are set by referencing the simulation model. The start time 1102 and the end time 1103 of each job are empty, the execution completion time 1104 is set to 0 minute, and the state 1105 is set to “unexecuted”. For the executing computer 1106, the value of the executing computer 802 of each job is set by referencing the simulation model. For the next event time 1107, the value of the start time 801 of each job is set by referencing the simulation model. For the simulation time 1108, the earliest time among the start times 801 is set. The event time 1109 and the event job name 1110 are left empty.

Judgment 1202 determines whether all the job states 1104 are “end” by referencing the simulation data. If all the job states are “end”, control is passed to YES. Otherwise, control is passed to NO.

Process 1203 searches the earliest time among the next event time 1107 in the simulation data, and this time is set as the event time 1109 and the job name 1101 which has searched this time is set as the event job name 1110.

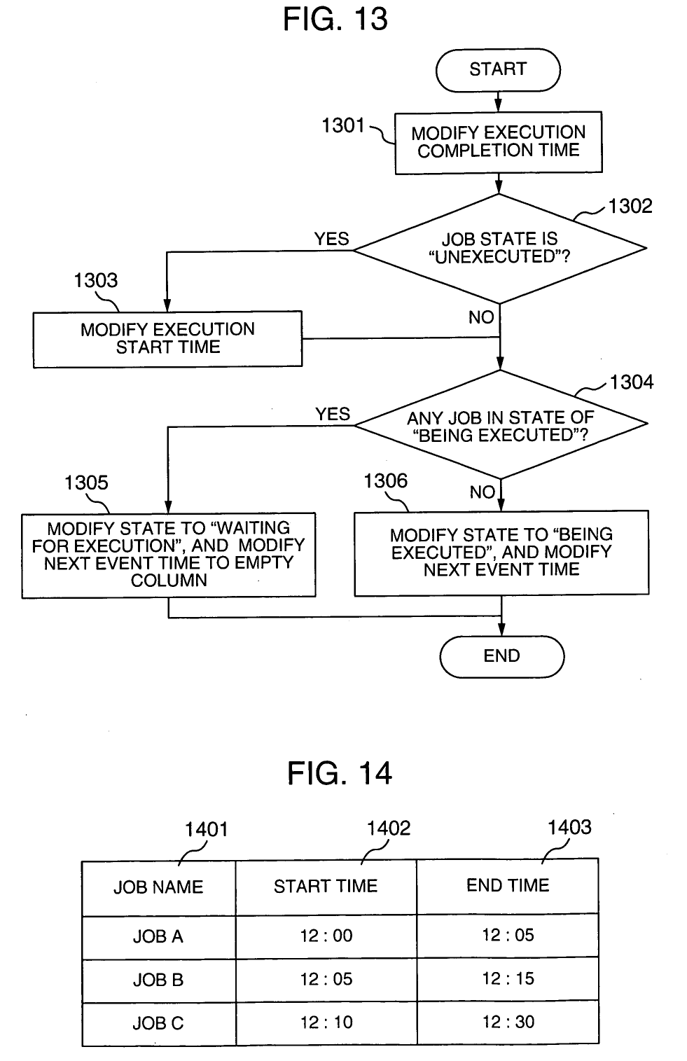

Process 1204 modifies the start time 1102, the execution completion time 1104, and the state 1105. FIG. 13 is a flowchart showing operation of the process 1204. Hereinafter, explanation will be given on the operation of process 1204 with reference to FIG. 13.

In process 1301, the execution completion time of all the jobs whose state 1105 is “being executed” is added by the time obtained by a difference between the event time 1109 and the simulation time 1108.

Judgment 1302 determines whether the event job name 1110 and the job state are “unexecuted” by referencing the simulation data state 1105.

Process 1303 modifies the start time 1102 of the simulation data of the job of the event job name 1110 to the value of the event time 1109.

Judgment 1304 searches the executing computer 1106 of the job of the event job name 1110 from the simulation data. By referencing the simulation data, judgment 1304 decides whether any job whose state is “being executed” is present in the same executing computer searched.

Process 1305 modifies the state 1105 of the job of the event job name 1110 to “waiting for execution” and the next event time 1107 to an empty column.

Process 1306 modifies the state 1105 of the job of the event job name 1110 to “being executed” and the next event time 1107 to the sum of the value of the simulation model event interval 804 and the value of the event time 1109.

Description is returned to the operation flowchart of the simulation execution section 303 in FIG. 12. Process 1105 modifies the end time 1103, the state 1105, and the simulation time 1108. For all the jobs, the execution completion time 1104 of the simulation data is compared to the required time 803 of the simulation model. If the execution completion time is equal to or greater than the required time, the job state 1105 is set to “end” and the end time 1103 is set to the value of the event time 1109. Moreover, the value of the event time 1109 is set for the simulation time 1108.

By the aforementioned operation of the simulation execution section 303, it is possible to obtain the simulation result consisting of the start time and end time of each job. FIG. 14 shows an example of the simulation result.

The evaluation section 304 calculates an evaluation value of the job execution plan from the simulation result. As an example of the evaluation value, it is possible to use the total time required for executing all the jobs. To calculate the total time required, the start time of the first job started and the end time of the last job ended are searched from the simulation result, and the difference between the end time and the start time is calculated. The evaluation value based on the total time required indicates a preferable execution plan as the time is reduced.

The output section includes a display device. The evaluation value calculated by the evaluation section is indicated on the display, thereby presenting the evaluation value of the job execution plan to a user. Here, together with the evaluation value, it is possible to show the simulation model of FIG. 8 on the display for the user.

It should be further understood by those skilled in the art that although the foregoing description has been made on embodiments of the invention, the invention is not limited thereto and various changes and modifications may be made without departing from the spirit of the invention and the scope of the appended claims.

1. An evaluation system for evaluating a job execution plan by using a simulation, comprising:
an input section enabling input of the job execution plan and a limit time;
a model database for storing a job model;
a model creation section for creating a simulation model from the job model stored in the model database;
a simulation execution section for executing the simulation;
an evaluation section for evaluating the execution plan from the simulation result; and
an output section for outputting the evaluation result.

2. The evaluation system according to claim 1, further comprising a performance storage section for storing a performance value of a computer executing the simulation.

3. The evaluation system according to claim 2, wherein the model creation section modifies the method for creating the simulation model according to the limit time input to the input section and the performance value stored in the performance storage section.

4. The evaluation system according to claim 3, wherein the model creation section modifies the method for creating the model so that the time required for executing the simulation of the simulation execution section is equal to or below the limit time input to the input section.

5. The evaluation system according to claim 3, wherein the method for creating the simulation model from the job model by the model creation section includes a step of setting a parameter of the simulation model and the model creation section calculates the job interference degree from the execution plan input to the input section and modifies the simulation model parameter according to the interference degree calculated.

6. The evaluation system according to claim 3, wherein the output section outputs the simulation model created by the model creation section.
